(19) United States
(12) Patent Application Publication
(10) Pub. No.: US 2025/0111967 A1
(43) Pub. Date: Apr. 3, 2025

(54) SOFT MAGNETIC METAL PARTICLE, DUST CORE, AND MAGNETIC COMPONENT

(71) Applicant: TDK Corporation, Tokyo (JP)

(72) Inventors: Ryoma NAKAZAWA, TOKYO (JP); Hiroyuki ONO, TOKYO (JP)

(73) Assignee: TDK Corporation, Tokyo (JP)

(21) Appl. No.: 18/898,794

(22) Filed: Sep. 27, 2024

(30) Foreign Application Priority Data
Sep. 29, 2023 (JP) 2023-170014

(51) Int. Cl. H01F 1/24; B22F 1/17; H01F 3/08

(52) U.S. Cl. CPC H01F 1/24; B22F 1/17; H01F 3/08

(57) ABSTRACT

A soft magnetic metal particle may include a core particle and an insulation coating formed on a surface of the core particle. The insulation coating may include a first layer, a second layer, and a third layer. The first layer may contact the surface of the core particle, and the second layer may contact the first layer and the third layer. The first layer may include at least Fe, the second layer may include at least Ti, and the third layer may include at least Si.

This application claims priority to Japanese patent application No. 2023-170014 filed on Sep. 29, 2023 which is incorporated herein by reference in its entirety.

### TECHNICAL FIELD

The present disclosure relates to a soft magnetic metal particle, a dust core, and a magnetic component.

### BACKGROUND

Patent Document 1 discloses an insulation coating which controls an aspect ratio of a flat powder, and also discloses that the insulation coating covering the flat powder is made of a polymer including titanium alkoxides.

Patent Document 2 discloses a magnetic material which includes a soft magnetic metal particle coated with a plurality of types of oxide coatings.
[Patent Document 1] WO2015/033825
[Patent Document 2] JP Patent Application Laid Open No. 2018-11043

### SUMMARY

A soft magnetic metal particle according to one aspect of the present disclosure includes:
a core particle and an insulation coating formed on a surface of the core particle,
wherein the insulation coating includes a first layer, a second layer, and a third layer;
the first layer contacts the surface of the core particle, and the second layer contacts the first layer and the third layer; and
the first layer at least includes Fe, the second layer at least includes Ti, and the third layer at least includes Si.

A dust core according to one aspect of the present disclosure includes the above-mentioned soft magnetic metal particle.

A magnetic component according to one aspect of the present disclosure includes the above-mentioned soft magnetic metal particle.

### BRIEF DESCRIPTION OF DRAWINGS

FIG. 1 is a schematic view of a cross section of a dust core according to one aspect of the present disclosure.

FIG. 2 shows TEM images and mapping images of a cross section of a soft magnetic metal particle according to one aspect of the present disclosure.

FIG. 3 shows images of an area surrounding an insulation coating of FIG. 2 enlarged in a thickness direction.

### DETAILED DESCRIPTION

In below, embodiments of the present disclosure are described using the figures. The embodiments described hereinbelow are examples used for explaining the present disclosure. Various configurational elements according to the embodiments of the present disclosure, such as numerical values, shapes, materials, production steps, etc., can be modified and changed as long as technical problems do not occur.

Also, the shapes shown in the figures of the present disclosure do not necessarily represent the actual sizes. This is because, in some cases, the shapes are modified for the sake of explanation.

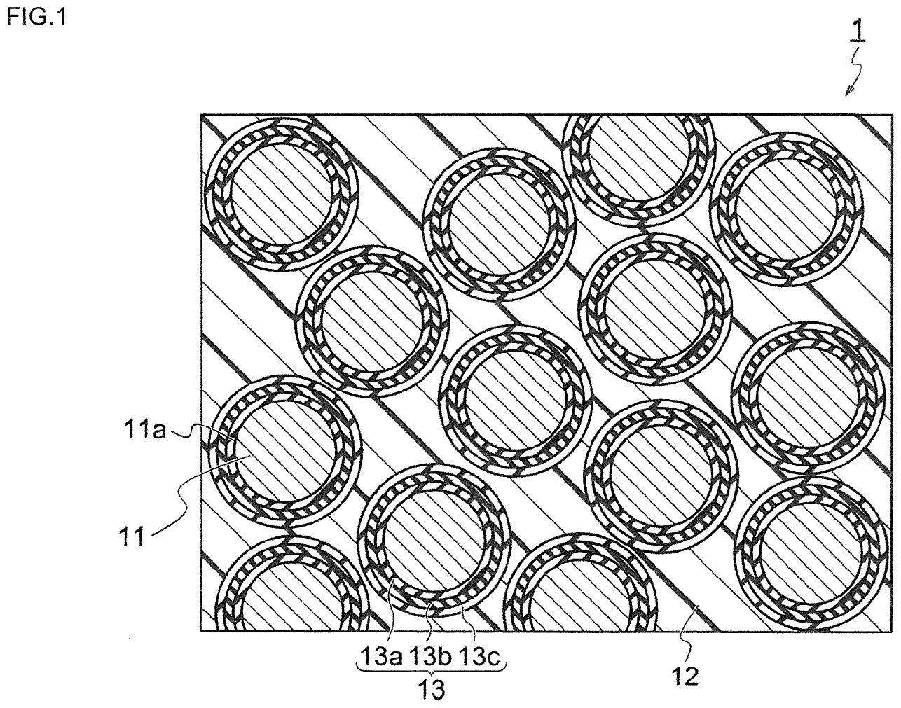

As shown in FIG. 1, a dust core 1 according to one embodiment of the present disclosure includes the magnetic metal particle (core particle) 11 and a grain boundary phase 12. Further, the dust core 1 includes an insulation coating 13 formed on a surface 11a of the core particle 11. The insulation coating 13 includes a first layer 13a, a second layer 13b, and a third layer 13c. The second layer 13b contacts the first layer 13a and the third layer 13c. The first layer 13a at least includes Fe. The second layer 13b at least includes Ti. The third layer 13c at least includes Si. Also, in some embodiments, the insulation coating 13 has a layer which is different from the third layer 13c at outside of the third layer 13c.

The soft magnetic metal particle according to one embodiment of the present disclosure includes the core particle 11 and the insulation coating 13 formed on the surface 11a of the core particle 11. Further, the soft magnetic metal particle includes the insulation coating 13 formed on the surface 11a of the core particle 11. The insulation coating 13 includes the first layer 13a, the second layer 13b, and the third layer 13c. The second layer 13b contacts the first layer 13a and the third layer 13c. The first layer 13a at least includes Fe. The second layer 13b at least includes Ti. The third layer 13c at least includes Si. Also, in some embodiments, the insulation coating 13 has a layer which is different from the third layer 13c at outside of the third layer 13c.

Regarding the dust core including the soft magnetic metal particle satisfying the above-mentioned configuration, an initial permeability μi tends to become high.

In some embodiments, a thickness of the insulation coating 13 is 5 nm or thicker and 500 nm or thinner. In some embodiments, the thickness of the insulation coating 13 is 10 nm or thicker and 200 nm or thinner.

In some of the embodiments, a thickness of the second layer 13b is 1.0% or more and 75.0% or less of the thickness of the insulation coating 13. In some embodiments, the thickness of the second layer 13b is 2.0% or more and 50.0% or less of the thickness of the insulation coating 13. In the case that the thickness of the second layer 13b is 2.0% or more and 50.0% or less of the thickness of the insulation coating 13, the initial permeability μi tends to become high.

A ratio of the thickness of the first layer 13a to the thickness of the insulation coating 13 is not particularly limited. For example, in some embodiments, the thickness of the first layer 13a is 10.0% or more and 35.0% or less of the thickness of the insulation coating 13. A ratio of a thickness of the third layer 13c to the thickness of the insulation coating 13 is not particularly limited. For example, in some embodiments, the thickness of the third layer 13c is 10.0% or more and 70.0% or less of the thickness of the insulation coating 13.

A thickness of each of the first layer 13a, the second layer 13b, and the third layer 13c is 0.7 nm or thicker. In other words, a layer with a thickness of less than 0.7 nm is neither considered as the first layer 13a, the second layer 13b, nor the third layer 13c.

A content of Fe in the first layer 13a is not particularly limited. For example, in some embodiments, a content ratio of Fe is 50.0 at % or more and 95.0 at % or less to a total content of Fe, Si, and Ti.

A content of Ti in the second layer 13b is not particularly limited. For example, in some embodiments, a content ratio of Ti is 1.0 at % or more and 10.0 at % or less to a total content of Fe, Si, and Ti.

In some embodiments, the second layer 13b further includes Si. Further, in some embodiments, a content ratio of Ti is 7.5 at % or more and 20.0 at % or less to a total content of Si and Ti in the second layer 13b (hereinafter, the content ratio of Ti is simply referred to as Ti/(Si+Ti)). In the case that Ti/(Si+Ti) is 7.5 at % or more and 20.0 at % or less, an initial permeability μi tends to increase easily.

A content of Si in the third layer 13c is not particularly limited. For example, in some embodiments, a content ratio of Si to a total content of Fe, Si, and Ti in the third layer 13c is 50.0 at % or more and 90.0 at % or less.

In some embodiments, the third layer 13c further includes Fe. Further, in some embodiments, Ti/(Si+Ti) in the second layer 13b is 7.5 at % or more and 20.0 at % or less, and the content ratio of Fe is 10.0 at % or more and 50.0 at % or less to the total content of Fe and Si in the third layer 13c (hereinafter, the content ratio of Fe is simply referred to as Fe/(Si+Fe)). In such case, particularly the initial permeability μi tends to become high.

It is not particularly limited as to how Fe is included in the first layer 13a. For example, in some embodiments, as described later, in the case that the core particle 11 includes Fe, oxides of Fe are included. In the case that the core particle 11 includes Fe and other elements, in some embodiments, oxides of Fe and oxides of other elements are included. In some embodiments, composite oxides of Fe and other elements are included. Also, in some embodiments, a compound other than oxides including Fe is included in the first layer 13a.

It is not particularly limited as to how Ti is included in the second layer 13b. For example, in some embodiments, simple Ti are scattered in the second layer 13b. Also, in some embodiments, a compound including Ti is included in the second layer 13b. The type of the compound including Ti is not particularly limited. Examples of the compound including Ti include an organometallic compound including Ti such as titanium alkoxide, titanate, etc., (metal complexes including Ti as a center metal). Also, in some embodiments, the compound including Ti is a single oxide of Ti. In some embodiments, the compound including Ti is a composite oxide of Ti and other elements. In some embodiments, a composite oxide of Si and Ti is included in the second layer 13b.

In some embodiments, the first layer 13a, the second layer 13b, and/or the third layer 13c include an oxide of Si. A type of the oxide of Si is not particularly limited. For example, in some embodiments, the oxide of Si is a Si—O based oxide (silicon oxide). Also, a type of Si—O based oxide is not particularly limited. For example, in some embodiments, the Si—O based oxide is an oxide of Si such as SiO₂, or a composite oxide including Si and other elements.

Components of the core particle 11 is not particularly limited as long as a material exhibiting soft magnetic properties is included, and in some embodiments, the core particle 11 includes Fe. In the case that the core particle 11 includes Fe as a main component, a saturation magnetization tends to become high. In the case that the core particle 11 includes Fe and Si as the main component, the initial permeability μi tends to become high. In the case that the core particle 11 includes Fe and Ni as the main component, the initial permeability μi tends to become high. In the case that the core particle 11 includes Fe and Co as the main component, the initial permeability μi tends to become high.

Note that, “includes as the main component” means that a content ratio of each element included in the main component is 1 wt % or more, a total content ratio of the element(s) included as the main component is 40 wt % or more, and a content ratio of each element other than the main component element(s) is lower than the content ratio of the element of lowest content ratio among the main component element(s).

In the case that the core particle 11 includes Fe as the main component, the content ratio of Fe is 40 wt % or more, and the content ratio of each element other than Fe is lower than the content ratio of Fe. The components included in the core particle 11, other than the main component, are not particularly limited. Examples of the components other than the main component (Fe) include Ni, Co, Si, Zr, V, etc.

In the case that the core particle 11 includes a combination of Fe and Si as the main component, the content ratio of Fe is 1 wt % or more and the content ratio of Si is 1 wt % or more, a total content ratio of Fe and Si is 40 wt % or more, and a content ratio of each element other than Fe and Si is lower than the content ratio of Fe or Si with a lower content ratio among these two. Note that, the components other than the main component (Fe and Si) in the core particle 11 is not particularly limited, and for example, Ni, Co, Zr, V, etc., may be mentioned.

In the case that the core particle 11 includes Fe, or a combination of Fe and Si as the main component, a content ratio of each of Fe and Si in the core particle 11 is not particularly limited. In some embodiments, a content ratio of Si to Fe in the core particle 11 is Si/Fe=0/100 to 20/80 in terms of weight ratio. In the case that the content ratio of Si to Fe in the core particle 11 is Si/Fe=0/100 to 10/90 in terms of weight ratio, the saturation magnetization tends to become high.

In the case that the core particle 11 includes a combination of Fe and Ni as the main component, the content ratio of Fe is 1 wt % or more, the content ratio of Ni is 1 wt % or more, a total content ratio of Fe and Ni is 40 wt % or more, and a content ratio of each element other than Fe and Ni is lower than the content ratio of Fe or Ni with a lower content ratio among these two. Note that, the components other than the main component included in the core particle 11 are not particularly limited. Examples of the components other than main component (Fe and Ni) include Co, Si, Zr, V, etc.

In the case that the core particle 11 includes Fe, or a combination of Fe and Ni, a content ratio of Ni to Fe in the core particle 11 is not particularly limited. In some embodiments, a content ratio of Ni to Fe in the core particle 11 is Ni/Fe=0/100 to 75/25 in terms of weight ratio.

In the case that the core particle 11 includes a combination of Fe and Co as the main component, a content ratio of Fe is 1 wt % or more, a content ratio of Co is 1 wt % or more, a total content ratio of Fe and Co is 40 wt % or more, and a content ratio of each element other than Fe and Co is lower than the content ratio of Fe or Co with a lower content ratio among these two. Note that, the components other than the main component included in the core particle 11 are not particularly limited. Examples of the components other than the main component (Fe and Co) include Ni, Si, Zr, V, etc.

In the case that the core particle 11 includes Fe, or a combination of Fe and Co as the main component, a content ratio of Co to Fe in the core particle 11 is not particularly limited. In some embodiments, a content ratio of Co to Fe in the core particle 11 is Co/Fe=0/100 to 50/50 in terms of weight ratio.

In some embodiments, the insulation coating 13 does not coat the entire surface 11a of the core particle 11. In some embodiments, the insulation coating layer 13 coats 90% or more of the entire surface 11a of the core particle 11.

The insulation coating 13 is directly formed on the surface of the core particle 11. That is, the surface 11a of the core particle 11 and the insulation coating 13 are in contact.

In some embodiments, the insulation coating 13 includes metal elements other than Fe and Ti in addition to Fe and Ti. Examples of the metal elements other than Fe and Ti include metal elements which the oxides thereof exhibit an insulation property such as Ba, Ca, Mg, Al, Zr, Ni, Mn, Zn. Among these, Ca, Mg, Zr, Ni, Mn, Zn are introduced relatively easily into the insulation coating. A content of metal elements other than Fe and Ti is not particularly limited. For example, in some embodiments, a content ratio of each metal element other than Fe and Ti is 1 mol % or less with respect to the total content of Fe and Ti.

There is no particular limitation in regards with a method of verifying whether the insulation coating 13 includes the first layer 13a, the second layer 13b, and the third layer 13c. In some embodiments, SEM-EDS, STEM-EDS, TEM-EDS, etc., are used for verification.

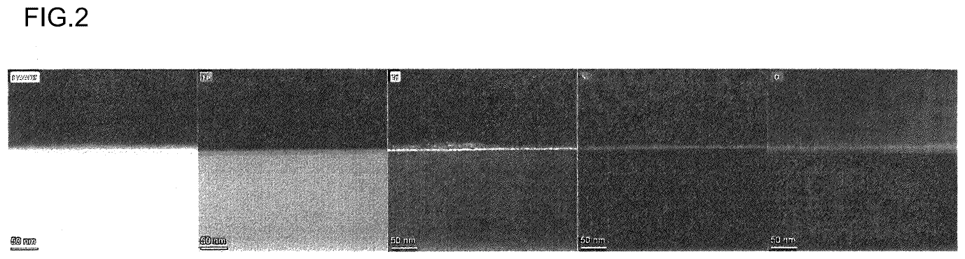

For example, FIG. 2 shows a TEM image of the cross section of the soft magnetic metal particle, and also shows mapping images of each of Fe, Ti, Si, and O which are formed using TEM-EDS. A bright field part at a lower side of the TEM image of FIG. 2 is the part which corresponds to the core particle 11 of FIG. 1; and a dark field compared to the core particle 11 is the part which corresponds to the insulation coating 13 of FIG. 1.

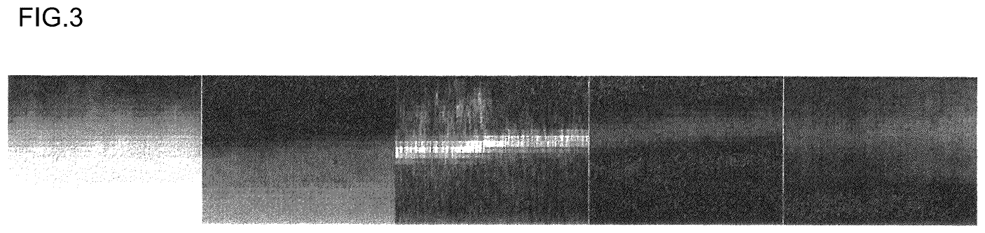

Further, FIG. 3 shows images of an area surrounding an insulation coating 13 of FIG. 2 enlarged in a thickness direction. From the mapping images of FIG. 2 and FIG. 3, it can be understood that Fe is more abundant in the first layer 13a and the second layer 13b among the three layers of the insulation coating 13. It can be also understood that Ti is more abundant in the second layer 13b among the three layers of the insulation coating 13. It can be also understood that Si is most abundant in the third layer 13c, and second most abundant in the first layer 13a among the three layers of the insulation coating 13. It can be understood that O is abundant in all of the first layer 13a to the third layer 13c. That is, according to TEM-EDS, it can be understood that the insulation coating 13 includes the first layer 13a which at least includes Fe, the second layer 13b which at least includes Ti, and the third layer 13c which at least includes Si.

In below, an example of a method for measuring the thickness of the insulation coating 13 and a thickness of each layer is described. Note that, the method for measuring the thickness of the insulation coating 13 and the thickness of each layer is not limited to the method described in below.

The thickness of the insulation coating 13 can be measured using a TEM image. A magnification of the TEM image is not particularly limited as long as the thickness of the insulation coating 13 can be confirmed. For example, in some embodiments, the magnification is 100000× or higher and 500000× or lower.

In some embodiments, the position of the second layer 13b in the insulation coating 13 is confirmed by a line analysis using TEM-EDS regarding Ti. Specifically, first, using TEM-EDS to the insulation coating 13, a line analysis is performed in a thickness direction. Next, regarding the obtained signal intensity, a base line is removed, and a peak of the signal intensity is identified by removing the base line. Then, the signal intensity at the peak is considered as 100%, and the part where the signal intensity is 20% is considered as the second layer 13b. Further, the part which is closer to the core particle 11 than the second layer 13b among the three layers of the insulation coating 13 is considered as the first layer 13a, and the part which is further away from the core particle 11 than the second layer 13b among the three layers of the insulation coating 13 is considered the third layer 13c.

In some embodiments, using the position of each layer identified by the above-mentioned method, the thickness of each layer is verified.

A method for measuring compositions of each layer is not particularly limited. In some embodiments, for example, sufficient number of measuring points are set in each layer to calculate the compositions of each measuring point using EDS, and the average is calculated. Thereby, the compositions of each layer is measured.

The dust core 1 includes a grain boundary phase 12 between the soft magnetic metal particles included in the dust core 1. Types of compounds included in the grain boundary phase 12 are not particularly limited. In some embodiments, examples of the compounds include a silicone resin, an epoxy resin, an imide resin, and/or Si—O based oxides. Also, in some embodiments, the grain boundary phase 12 includes a void. In some embodiments, examples of the silicone resin included in the grain boundary phase 12 include a methyl-based silicone resin, etc. Examples of the epoxy resin include cresol novolac epoxy resin, etc. Examples of the imide resin include bismaleimide resin, etc.

Note that, due to a heat treatment which is described later, there may be cases that a part of or an entire silicon resin included in the grain boundary phase 12 changes into Si—O based oxides such as SiO₂, etc.

The content of the core particle 11 and the content of the compounds included in the grain boundary phase 12 are not particularly limited. In some embodiments, the core particle 11 occupies 90 wt % to 99.9 wt % of the dust core 1 as a whole. The compounds included in the grain boundary phase 12 occupy 0.1 wt % to 10 wt % of the dust core 1 as a whole.

A method for observing the cross section of the dust core 1 is not particularly limited. In some embodiments, for example, the dust core 1 is observed using SEM, STEM, or TEM under an appropriate magnification. In some embodiments, by further carrying out an EDS analysis, the composition at each point of the dust core 1 is measured.

A method for producing the dust core 1 according to the present embodiment is shown in below, however, the method for producing the dust core 1 is not limited to the below-described method.

First, the core particle 11 is formed. A method for forming the core particle 11 is not particularly limited, and examples of the method include a gas atomization method, a water atomization method, etc. A particle size and a circularity of the core particle 11 is not particularly limited. In the case that a median (D50) of the particle sizes is 1 μm to 100 μm, an initial permeability μi tends to become high. In some embodiments, a circularity of the core particle 11 is, for example, 0.5 or more and 1 or less. In some embodiments, the circularity of the core particle 11 is 0.7 or more and 1 or less. In some embodiments, the circularity of the core particle 11 is 0.8 or more and 1 or less.

Next, the insulation coating 13 is formed on the surface 11a of the core particle 11.

First, the first layer 13a is formed on the surface 11a of the core particle 11. A method for forming the first layer 13a is not particularly limited. In the case that the core particle includes Fe, in some embodiments, the first layer 13a is formed by oxidizing the surface of the core particle 11. A method for oxidizing the surface of the core particle 11 is not particularly limited. In some embodiments, for example, a heat treatment is carried out in atmosphere including oxygen. In some embodiments, a thickness of the first layer 13a is controlled by appropriately adjusting an oxygen concentration in the atmosphere, a heat treatment temperature, and a heat treatment time.

Also, in some embodiments, a coating solution including Fe is coated over the core particle 11, thereby, the first layer 13a including Fe is formed.

Next, the second layer 13b is formed on the surface of the first layer 13a. A method for forming the second layer 13b is not particularly limited. For example, in some embodiments, a coating solution including alkoxy silane and Ti is coated over the core particle 11. Note that, in some embodiments, in the case that Si is not included in the second layer 13b, alkoxy silane is not included in the coating solution. A method for coating the coating solution over the core particle 11 is not particularly limited, and examples of the method include a method using spray diffusion. There is no particular limitation as to how Ti is included in the coating solution. For example, in some embodiments, Ti is included as titanium alkoxide. In some embodiments, Ti is included as titanate. In the case that Ti is included as titanate or titanium alkoxide and also that the below described heat treatment is carried out, titanate or the titanium alkoxide decomposes due to the heat treatment. Hereinbelow, the case of adding titanium alkoxide in the coating solution is described.

A concentration of alkoxysilane, a concentration of titanium alkoxide, and a type of the solvent in the coating solution are not particularly limited. In some embodiments, the concentration of alkoxysilane and the concentration of titanium alkoxide are determined based on the target value of Ti/(Si+Ti), and the target thickness of the insulation coating 13.

Examples of alkoxysilane include monoalkoxysilane, dialkoxysilane, trialkoxysilane, and tetraalkoxysilane. Examples of monoalkoxysilane include trimethylmethoxysilane, trimethylethoxysilane, trimethyl(phenoxy)silane, etc. Examples of dialkoxysilane include dimethyldimethoxysilane, dimethyldiethoxysilane, diisopropyldimethoxysilane, diisobutyldimethoxysilane, t-butylmethyldimethoxysilane, t-butylmethyldiethoxysilane, etc. Examples of trialkoxysilane include ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, etc. Examples of tetraalkoxysilane include tetramethoxysilane, tetraethoxysilane, tetrapropoxysilane, tetraisopropoxysilane, etc. In some embodiments, one type of alkoxysilane is used. In some embodiments, two or more types of alkoxysilane are used together.

Examples of titanium alkoxide include titanium tetramethoxide, titanium tetraethoxide, titanium tetra-n-propoxide, titanium tetraisopropoxide, titanium tetra-n-butoxide, etc. In some embodiments, one type of titanium alkoxide is used. In some embodiments, two or more types of titanium alkoxide are used together. In some embodiments, titanium alkoxide is titanium tetraethoxide or titanium tetra-n-butoxide as it is readily available.

Examples of the solvent include water, ethanol, isopropyl alcohol, etc.

Also, in some embodiments, when performing spray diffusion, a proportion of alkoxysilane is 0.1 wt % to 5 wt % with respect to the amount of the core particles 11 as a whole. Also, the more alkoxysilane is included, the thicker the second layer 13b tends to be.

Conditions of spray diffusion are not particularly limited, however, by carrying out spray diffusion while heat treating at a temperature of 50° C. to 90° C., a sol-gel reaction forming the second layer 13b tends to be facilitated.

The core particle 11, to which the spray diffusion has been carried out, is dried to remove the solvent. Then, heating is carried out for 1 to 10 hours at a temperature of 200° C. to 400° C., thereby, a sol-gel reaction proceeds and the second layer 13b is formed. The higher the heating temperature and the longer the heating time is at this point, the higher the density of the second layer 13b tends to be.

When titanate is added to the coating solution, except for replacing the above-mentioned titanium alkoxide with titanate, it is similar to the case of adding titanium alkoxide to the coating solution. Examples of titanate include titanium acetylacetonate, titanium tetraacetylacetonate, titanium ethylacetoacetate, titanium octylene glycolate, titanium lactate, titanium triethanolamine, titanium diethanolamine, etc. In some embodiments, one type of titanate is used. In some embodiments, two or more types of titanate is used together.

Next, the third layer 13c is formed on the surface of the second layer 13b. A method of forming the third layer 13c is not particularly limited. For example, a method for coating the coating solution including alkoxysilane over the core particle 11 may be mentioned. A method for coating the coating solution over the core particle 11 is not particularly limited, and examples of the method include a method using spray diffusion. A type of alkoxysilane is not particularly limited, and in some embodiments, at least one of the above-mentioned types of alkoxysilane is used. A type of the solvent is not particularly limited, and in some embodiments, at least one of the above-mentioned types of solvent is used.

Also, during the spray diffusion, in some embodiments, a proportion of alkoxysilane is 0.1 wt % to 5 wt % with respect to the amount of the core particles 11 as a whole. Also, the more alkoxysilane is included, the thicker the third layer 13c tends to be.

Conditions of spray diffusion are not particularly limited, and by carrying out spray diffusion while heat treating at temperature of 50° C. to 90° C., a sol-gel reaction forming the third layer 13c tends to be facilitated.

After the solvent is removed by drying the core particle 11 to which the coating solution is spray diffused, heating is carried out for 1 to 10 hours at a temperature of 200° C. to 400° C., thereby, a sol-gel reaction proceeds and the third layer 13c is formed. The higher the heating temperature is and the longer the heating time is at this point, the higher the density of the third layer 13c tends to be.

A method to include Fe in the third layer 13c is not particularly limited. For example, in some embodiments, a compound including Fe is further added to the above-mentioned coating solution. Examples of the compound including Fe include iron acetate, iron chloride, and iron sulfate.

A concentration of alkoxysilane, a concentration of the compound including Fe, and a type of the solvent in the coating solution are not particularly limited. In some embodiments, the concentration of alkoxysilane and the concentration of compound including Fe are determined based on the target value of Fe/(Si+Fe), and the target thickness of the third layer 13c.

Next, in the case that the grain boundary phase 12 in a green compact of before the below-described heat treatment includes a resin, a resin solution is formed. In some embodiments, the above-mentioned silicone resin, an epoxy resin and/or an imide resin, and also a curing agent are added in the resin solution. A type of a curing agent is not particularly limited, and examples of the curing agent include epichlorohydrin, etc. Also, a solvent of the resin solution is not particularly limited, and in some embodiments, a volatile solvent is used for the solvent of the resin solution. For example, in some embodiments, as the solvent of the resin solution, acetone, ethanol, etc., is used. Also, in some embodiments, a total concentration of the resin and the curing agent is 10 to 80 wt % with respect to 100 wt % of the resin solution as a whole.

Next, the core particles 11 formed with the insulation coating 13 are mixed with the resin solution. That is, the soft magnetic particles and the resin solution are mixed. Then, the solvent of the resin solution is evaporated to obtain the grains. In some embodiments, the obtained grains are directly placed in a mold. In some embodiments, the obtained grains are selected by sizes and then placed in the mold. A method for selecting the grains by sizes is not particularly limited, and for example, in some embodiments, a mesh with an aperture of 45 to 500 μm is used.

Next, the mold having a predetermined shape is filled with the obtained grains, then pressure is applied to obtain the green compact. The pressure during the pressurization (molding pressure) is not particularly limited, and for example, in some embodiments, the pressure of 500 to 1500 MPa is applied. The higher the molding pressure is, the higher the initial permeability μi of the dust core 1 obtained at the end tends to be.

When comparing the case in which the insulation coating 13 includes all of the first layer 13a to the third layer 13c and the case in which the insulation coating 13 does not include one or more of the three layers, even if the same molding pressure is applied, an initial permeability μi of the dust core 1 is higher when the insulation coating 13 includes all of the first layer 13a to the third layer 13c.

In some embodiments, the obtained green compact is used as the dust core. Also, in some embodiments, the obtained green compact is heat treated to obtain a sintered body, and this sintered body is used as the dust core. Conditions for the heat treatment are not particularly limited. In the case that the silicone resin is used as the resin, in some embodiments, the heat treatment is carried out under the condition that the silicone resin can sinter. In some embodiments, for example, the heat treatment is carried out at a temperature of 400° C. to 1000° C. for 0.1 hour to 10 hours. Also, atmosphere during the heat treatment is not particularly limited, and in some embodiments, the heat treatment is carried out in the air. In some embodiments, the heat treatment is carried out in nitrogen atmosphere.

In the case that titanate or titanium alkoxide is included in the green compact, in some embodiments, titanate or the titanium alkoxide partially or entirely decomposes due to the above-mentioned heat treatment. Particularly in regards with titanate, in some embodiments, it is entirely decomposed by heat treating at a temperature of 700° C. or higher and 1000° C. or lower. That is, in some embodiments, by heat treating at a temperature of 700° C. or higher and 1000° C. or lower, it is ensured that the sintered body does not include titanate.

Hereinabove, the dust core according to the present embodiment and the method for producing thereof have been described, however, the durst core and the method for producing thereof of the present disclosure is not limited to the above-mentioned embodiments.

Also, the use of the dust core of the present disclosure is not particularly limited. For example, the dust core of the present disclosure is used in magnetic components such as an inductor, a reactor, a choke coil, a transformer, etc. The magnetic component of the present disclosure includes the above-mentioned dust core.

### Examples

Hereinafter, the present disclosure is explained based on detailed examples, however, the present disclosure is not to be limited to these examples.

As a magnetic metal particle (core particle), a Fe—Si based alloy particle (alloy particle including Fe and Si as a main component) was formed using a gas atomization method. In the magnetic metal particle, a proportion of Si to Fe was Si/Fe=4.5/95.5 in terms of weight ratio and a total amount of Fe and Si was 99 wt % or more. Note that, a median particle size (D50) of the Fe—Si based alloy particles was 30 μm, and a circularity was about 0.90.

First, a first layer was formed on a surface of the magnetic metal particle. The first layer was formed by oxidizing the surface of the magnetic metal particle. Specifically, the magnetic metal particle was heat treated at 800° C. in nitrogen atmosphere where an oxygen concentration was adjusted. The oxygen concentration and a heating time were adjusted so as to form the first layer having the thickness as shown in Table 1 to Table 4. The oxygen concentration was 0.1 to 1.0% and the heating time was 1 to 10 hours.

Next, coating solutions for forming a second layer and a third layer were prepared.

A coating solution for forming the second layer (hereinafter, it may be referred to as a second layer coating solution) was formed by mixing 15 parts by weight of ethanol, trimethoxysilane, titanium tetra-n-butoxide, and 2.0 parts by weight of pure water to 100 parts by weight of the magnetic metal particles as a whole. Amounts of trimethoxysilane and titanium tetra-n-butoxide were adjusted so that a proportion represented by Ti/(Ti+Si) in the second layer of the insulation coating obtained at the end satisfied the value shown in Table 1 to Table 4. A total amount of trimethoxysilane and titanium tetra-n-butoxide were adjusted so as to form the second layer having a thickness as shown in Table 1 to Table 4.

A coating solution for forming the third layer (hereinafter, it may be referred to as a third layer coating solution) was formed by mixing 15 parts by weight of ethanol, trimethoxysilane, and iron acetate solution to 100 parts by weight of the magnetic metal particles as a whole. A proportion of trimethoxysilane to iron acetate solution, and a concentration of iron acetate solution were adjusted so that Fe/(Si+Fe) in the third layer of the insulation coating obtained at the end satisfied the value shown in Table 1 to Table 4. For samples shown in Table 1 to Table 4, pure water was mixed in place of the iron acetate solution. Also, a total amount of trimethoxysilane and iron acetate solution or pure water was adjusted so that the thickness of the third layer obtained at the end satisfied the value shown in Table 1 to Table 4.

For each example except for Comparative example 1, the second layer was formed on the surface of the first layer. The magnetic metal particle to which the first layer had been formed was mixed with the second layer coating solution, and heat treatment was performed while carrying out spray diffusion. A heat treatment temperature was 80° C. and a heat treatment time was 1 hour. Further, drying was carried out after the heat treatment, and thereby, the magnetic metal particle having the second layer on the surface of the first layer was obtained. Note that, for Comparative example 1 shown in Table 1, the second layer was not formed.

Next, for each example except for Comparative example 1, the third layer was formed on the surface of the second layer. The magnetic metal particle formed with the first layer and the second layer was mixed with the third layer coating solution, and a heat treatment was performed while carrying out spray diffusion. A heat treatment temperature was 80° C. and a heat treatment time was 1 hour. Further, drying was carried out after the heat treatment, and thereby, the magnetic metal particle having the third layer on the surface of the second layer was obtained.

For Comparative example 1, the third layer was formed on the first layer. The magnetic metal particle formed with the first layer was mixed with the third layer coating solution, and the heat treatment was performed while carrying out spray diffusion. A heat treatment temperature was 80° C. and a heat treatment time was 1 hour. Further, drying was carried out after the heat treatment, and thereby, the magnetic metal particle having the third layer on the first layer was obtained.

The obtained magnetic metal particles were passed through a sieve of 140 mesh, and then, a heat treatment was carried out. A heat treatment temperature was 300° C. and a heat treatment time was 5 hours.

Next, a silicone resin and acetone were mixed to make a resin solution. As the silicone resin, Shin-Etsu KR-242A (made by Shin-Etsu Chemical Co., Ltd.) was used. The silicone resin and acetone were mixed in a weight ratio of 34:66.

To 100 parts by weight of the magnetic metal particles as a whole, 6 parts by weight of the above-mentioned resin solution was added and mixed. Next, drying was carried out to evaporate acetone, and thereby, grains were obtained. Then, the grains were passed through a sieve of 42 mesh to select by sizes. The obtained grains were dried on a hot plate of 50° C. for 0.5 hour to form a granulated powder.

Then, 0.1 parts by weight of zinc stearate was added to 100 parts by weight of the granulated powder, and molding was carried out to obtain a toroidal core. An amount of the granulated powder placed in the mold was 5 g. The molding pressure was appropriately adjusted so that a density of the toroidal dust core obtained at the end was about 6.4 g/cm³. The shape of the mold was a toroidal shape having an outer diameter Φ of 17.5 mm, an inner diameter Φ of 10.0 mm, and a thickness of 4.8 mm.

The obtained toroidal core was heat treated at 700° C. for 1 hour, and a toroidal dust core was obtained. The magnetic metal particles were adjusted to be about 98 wt % with respect to 100 wt % of the dust core as a whole obtained at the end.

It was confirmed from TEM-EDS observation that each Example had an insulation coating including the first layer to the third layer, and Comparative example 1 had an insulation coating only including the first layer and the third layer.

For each Example, the thickness of the insulation coating was measured from TEM image, and the position of the second layer was identified by a line analysis of TEM-EDS observation. The thickness of the second layer was determined from the position of the second layer. Within the insulation coating, the part which was at inner side than the second layer, that is, the part closer to the core particle, was considered as the first layer; and the thickness of the first layer was identified. Within the insulation coating, the part at outer side than the second layer, that is, the part further away from the core particle, was considered as the third layer, and the thickness of the third layer was identified.

Specifically, the thickness of the insulation coating was measured by using a total thickness of the layers which form dark fields compared to the magnetic metal particle in the TEM image. Results are shown in Tables 1 to 4.

Next, Ti/(Si+Ti) in the second layer was quantified using EDS. Ten positions in the second layer were selected as measuring positions, and the average of Ti/(Si+Ti) of the measuring positions were calculated. The results are shown in Table 1 to Table 4.

Next, Fe/(Si+Fe) in the third layer was quantified using EDS. Ten positions in the third layer were selected as measuring positions, and the average of Fe/(Si+Fe) of the measuring positions were calculated. The results are shown in Table 1 to Table 4.

For Comparative example 1, a line analysis of TEM-EDS was used to differentiate the first layer and the third layer. A compositional analysis in regards with C, O, Si, Fe, and Ti was carried out, and the part where the Fe concentration was 50 at % or higher was determined as the first layer, and the part where the Si concentration was 20 at % or higher was considered as the third layer. A thickness of each layer was measured based on the result showing the first layer and the third layer. Results are shown in Table 1.

A wire was wound around the toroidal dust core for 50 turns, and an initial permeability μi of the toroidal dust core was measured using a LCR meter (LCR428A made by HP). The initial permeability μi within the between 40.0 or higher and lower than 45.0 was considered good, 45.0 or higher and lower than 50.0 was considered better, 50.0 or higher and lower than 55.0 was considered excellent, and 55.0 or higher was considered particularly excellent.

A density of the toroidal dust core was calculated using the size and the weight of the obtained dust core. It was confirmed that the density was about 6.4 g/cm³ for all of Examples and Comparative example.

TABLE 1

| | Insulation | | | | | | |
|---|---|---|---|---|---|---|---|
| | coating | Thickness/nm | | | Second layer | Third layer | Initial |
| Sample | thickness/ | First | Second | Third | Ti/(Si + Ti)/ | Fe/(Si + Fe)/ | permeability |
| No. | nm | layer | layer | layer | at % | at % | μi |
| Comparative | 50 | 16.2 | 0.0 | 33.8 | — | 0.0 | 39.5 |
| example 1 | | | | | | | |
| Example 1a | 50 | 16.0 | 0.7 | 33.3 | 5.0 | 0.0 | 42.1 |
| Example 1 | 50 | 15.9 | 1.0 | 33.1 | 5.0 | 0.0 | 45.1 |
| Example 2 | 50 | 15.2 | 3.0 | 31.8 | 5.0 | 0.0 | 47.5 |
| Example 3 | 50 | 14.6 | 5.0 | 30.4 | 5.0 | 0.0 | 48.1 |
| Example 4 | 50 | 13.3 | 9.1 | 27.6 | 5.0 | 0.0 | 48.9 |
| Example 5 | 50 | 12.3 | 12.0 | 25.7 | 5.0 | 0.0 | 48.7 |
| Example 6 | 50 | 11.4 | 15.0 | 23.6 | 5.0 | 0.0 | 48.5 |
| Example 7 | 50 | 10.7 | 17.0 | 22.3 | 5.0 | 0.0 | 47.5 |
| Example 8 | 50 | 9.7 | 20.0 | 20.3 | 5.0 | 0.0 | 46.1 |
| Example 9 | 50 | 8.1 | 25.0 | 16.9 | 5.0 | 0.0 | 45.2 |
| Example 10 | 50 | 6.5 | 30.0 | 13.5 | 5.0 | 0.0 | 42.1 |

TABLE 2

| | Insulation | | | | | | |
|---|---|---|---|---|---|---|---|
| | coating | Thickness/nm | | | Second layer | Third layer | Initial |
| Sample | thickness/ | First | Second | Third | Ti/(Si + Ti)/ | Fe/(Si + Fe)/ | permeability |
| No. | nm | layer | layer | layer | at % | at % | μi |
| Example 11 | 10 | 2.7 | 1.8 | 5.5 | 5.0 | 0.0 | 49.9 |
| Example 12 | 20 | 5.3 | 3.6 | 11.1 | 5.0 | 0.0 | 49.5 |
| Example 13 | 30 | 8.0 | 5.5 | 16.6 | 5.0 | 0.0 | 49.1 |
| Example 4 | 50 | 13.3 | 9.1 | 27.6 | 5.0 | 0.0 | 48.9 |
| Example 14 | 100 | 26.5 | 18.2 | 55.3 | 5.0 | 0.0 | 47.4 |
| Example 15 | 150 | 39.8 | 27.3 | 82.9 | 5.0 | 0.0 | 46.2 |
| Example 16 | 200 | 53.1 | 36.4 | 110.5 | 5.0 | 0.0 | 45.1 |

TABLE 3

| | Insulation | | | | | | |
|---|---|---|---|---|---|---|---|
| | coating | Thickness/nm | | | Second layer | Third layer | Initial |
| Sample | thickness/ | First | Second | Third | Ti/(Si + Ti)/ | Fe/(Si + Fe)/ | permeability |
| No. | nm | layer | layer | layer | at % | at % | μi |
| Example 17 | 50 | 13.3 | 9.1 | 27.6 | 2.5 | 0.0 | 48.7 |
| Example 4 | 50 | 13.3 | 9.1 | 27.6 | 5.0 | 0.0 | 48.9 |
| Example 18 | 50 | 13.3 | 9.1 | 27.6 | 7.5 | 0.0 | 50.1 |
| Example 19 | 50 | 13.3 | 9.1 | 27.6 | 10.0 | 0.0 | 54.8 |
| Example 20 | 50 | 13.3 | 9.1 | 27.6 | 12.5 | 0.0 | 54.9 |
| Example 21 | 50 | 13.3 | 9.1 | 27.6 | 15.0 | 0.0 | 54.7 |
| Example 22 | 50 | 13.3 | 9.1 | 27.6 | 17.5 | 0.0 | 53.1 |
| Example 23 | 50 | 13.3 | 9.1 | 27.6 | 20.0 | 0.0 | 50.1 |
| Example 24 | 50 | 13.3 | 9.1 | 27.6 | 27.5 | 0.0 | 49.5 |

TABLE 4

| | Insulation | | | | | | |
|---|---|---|---|---|---|---|---|
| | coating | Thickness/nm | | | Second layer | Third layer | Initial |
| Sample | thickness/ | First | Second | Third | Ti/(Si + Ti)/ | Fe/(Si + Fe)/ | permeability |
| No. | nm | layer | layer | layer | at % | at % | μi |
| Example 21 | 50 | 13.3 | 9.1 | 27.6 | 15.0 | 0.0 | 54.7 |
| Example 25a | 50 | 13.3 | 9.1 | 27.6 | 15.0 | 5.0 | 54.8 |
| Example 25 | 50 | 13.3 | 9.1 | 27.6 | 15.0 | 10.0 | 56.5 |
| Example 26 | 50 | 13.3 | 9.1 | 27.6 | 15.0 | 20.0 | 57.1 |
| Example 27 | 50 | 13.3 | 9.1 | 27.6 | 15.0 | 30.0 | 58.5 |
| Example 28 | 50 | 13.3 | 9.1 | 27.6 | 15.0 | 40.0 | 57.4 |
| Example 29 | 50 | 13.3 | 9.1 | 27.6 | 15.0 | 50.0 | 55.2 |
| Example 30 | 50 | 13.3 | 9.1 | 27.6 | 15.0 | 60.0 | 54.3 |

According to Table 1, when the thickness of the insulation coating and the density of the toroidal dust core were about the same, Examples 1a, and 1 to 10 which all included the first layer to the third layer exhibited good initial permeability μi compared to that of Comparative example 1 which did not include the second layer. Examples 1 to 9 in which the thickness of the second layer was 2.0% or thicker and 50.0% of the thickness of the insulation coating exhibited good initial permeability μi compared to Examples 1a and 10 in which the thickness of the second layer was thinner than 2.0% and thicker than 50.0% of the thickness of the insulation coating.

According to Table 2, even when the thickness of the insulation coating was changed from Example 4, a good initial permeability μi was exhibited.

Examples 17 to 24 of Table 3 are examples in which Ti/(Si+Ti) of the second layer was changed from that of Example 4 shown in Table 1. Examples 18 to 23 in which Ti/(Si+Ti) of the second layer was 7.5 at % or more and 20.0 at % or less exhibited good initial permeability μi compared to Examples 4, 17, and 24 in which Ti/(Si+Ti) of the second layer was less than 7.5 at % and more than 20.0 at %.

Examples 25a, and 25 to 30 shown in Table 4 are examples in which Fe/(Si+Fe) of the third layer was changed from that of Example 21 shown in Table 3. Examples 25 to 29 in which Fe/(Si+Fe) of the third layer was 10.0 at % or more and 50.0 at % or less exhibited good initial permeability μi compared to Examples 21, 25a, and 30 in which Fe/(Si+Fe) of the third layer was less than 10.0 at % and more than 50.0 at %.

### [Supplementary Notes]

Technologies according to the present disclosure includes below described configurational examples, however, the present disclosure is not to be limited thereto.

[1] A soft magnetic metal particle, including:
a core particle and an insulation coating formed on a surface of the core particle,
wherein the insulation coating includes a first layer, a second layer, and a third layer;
the first layer contacts the surface of the core particle, and the second layer contacts the first layer and the third layer; and
the first layer at least includes Fe, the second layer at least includes Ti, and the third layer at least includes Si.

[2] The soft magnetic metal particle according [1], wherein a thickness of the second layer with respect to a thickness of the insulation coating is 2.0% or more and 50.0% or less.

[3] The soft magnetic metal particle according to [1] or [2], wherein the second layer further comprises Si, and a content ratio of Ti in the second layer is 7.5 at % or more and 20.0 at % or less with respect to a total content of Si and Ti in the second layer.

[4] The soft magnetic metal particle according to any one of [1] to [3], wherein the third layer further includes Fe, and a content ratio of Fe in the third layer is 10.0 at % or more and 50.0 at % or less with respect to a total content of Fe and Si in the third layer.

[5] The soft magnetic metal particle according to any one [1] to [4], wherein the core particle includes Fe.

[6] The soft magnetic metal particle according to any one of [1] to [5], wherein a thickness of the insulation coating is 10 nm or thicker and 200 nm or thinner.

[7] A dust core including the soft magnetic metal particle according to any one of [1] to [6].

[8] A magnetic component including the soft magnetic metal particle according to any one of [1] to [6].

### REFERENCE SIGNS LISTS

1 . . . Dust core
11 . . . Magnetic metal particle (core particle)
11a . . . Surface of magnetic metal particle
12 . . . Grain boundary phase
13 . . . Insulation coating
13a . . . First layer
13b . . . Second layer
13c . . . Third layer

What is claimed is:

1. A soft magnetic metal particle, comprising:
a core particle and an insulation coating formed on a surface of the core particle,
wherein the insulation coating comprises a first layer, a second layer, and a third layer;
the first layer contacts the surface of the core particle, and the second layer contacts the first layer and the third layer; and
the first layer includes at least Fe, the second layer include at least Ti, and the third layer includes at least Si.

2. The soft magnetic metal particle according to claim 1, wherein a thickness of the second layer with respect to a thickness of the insulation coating is 2.0% or more and 50.0% or less.

3. The soft magnetic metal particle according to claim 2, wherein the second layer further comprises Si, and a content ratio of Ti in the second layer is 7.5 at % or more and 20.0 at % or less with respect to a total content of Si and Ti in the second layer.

4. The soft magnetic metal particle according to claim 3, wherein the third layer further comprises Fe, and a content ratio of Fe in the third layer is 10.0 at % or more and 50.0 at % or less with respect to a total content of Fe and Si in the third layer.

5. The soft magnetic metal particle according to claim 1, wherein the core particle comprises Fe.

6. The soft magnetic metal particle according to claim 5, wherein the core particle further comprises Si, Ni, or Co.

7. The soft magnetic metal particle according to claim 1, wherein a thickness of the insulation coating is 10 nm or thicker and 200 nm or thinner.

8. The soft magnetic metal particle according to claim 1, wherein a thickness of the first layer with respect to a thickness of the insulation coating is 10.0% or more and 35.0% or less.

9. The soft magnetic metal particle according to claim 1, wherein a thickness of the third layer with respect to a thickness of the insulation coating is 10.0% or more and 70.0% or less.

10. The soft magnetic metal particle according to claim 1, wherein a thickness of each of the first layer, the second layer, and the third layer is 0.7 nm or higher.

11. The soft magnetic metal particle according to claim 1, wherein the insulation coating coats 90% or more of the entire surface of the core particle.

12. The soft magnetic metal particle according to claim 1, wherein the insulation coating is directly formed on the surface of the core particle.

13. The soft magnetic metal particle according to claim 1, wherein the insulation coating further includes at least one metal element selected from the group consisting of Ba, Ca, Mg, Al, Zr, Ni, Mn, and Zn.

14. The soft magnetic metal particle according to claim 13, wherein a content ratio of each of the at least one metal element is 1 mol % or less with respect to a total content of Fe and Ti.

15. The soft magnetic metal particle according to claim 1, wherein a content ratio of Fe to a total content of Fe, Si, and Ti in the first layer is 50.0 at % or more and 95.0 at % or less.

16. The soft magnetic metal particle according to claim 1, wherein a content ratio of Ti to a total content of Fe, Si, and Ti in the second layer is 1.0 at % or more and 10.0 at % or less.

17. The soft magnetic metal particle according to claim 1, wherein a content ratio of Si to a total content of Fe, Si, and Ti in the third layer is 50.0 at % or more and 90.0 at % or less.

18. The soft magnetic metal particle according to claim 1, wherein the first layer, the second layer, and/or the third layer include an oxide of Si.

19. A dust core comprising the soft magnetic metal particle according to claim 1.

20. A magnetic component comprising the soft magnetic metal particle according to claim 1.
